(19) United States
(12) Patent Application Publication
(10) Pub. No.: US 2015/0199210 A1
(43) Pub. Date: Jul. 16, 2015

(54) Methods, Devices and Computer Readable Storage Devices for Confluence of Multiple Operating Systems

(71) Applicant: American Megatrends, Inc., Norcross, GA (US)

(72) Inventors: Govind Kothandapani, Snellville, GA (US); Vinothkumar Sundaramoorthy, Norcross, GA (US)

(73) Assignee: American Megatrends, Inc., Norcross, GA (US)

(21) Appl. No.: 14/155,471

(22) Filed: Jan. 15, 2014

(51) Int. Cl. G06F 9/455

(52) U.S. Cl. CPC G06F 9/45545

(57) ABSTRACT

A secondary operating system, which is a virtual operating system executing as a guest of a primary operating system, is provided with access to resources associated with a computing device executing the primary operating system. A request is received from an application associated with the secondary operating system at a hardware abstraction layer associated with the secondary operating system. The application and the hardware abstraction layer are executed in a user mode layer associated with the secondary operating system. The request is sent from the hardware abstraction layer to an application associated with the primary operating system. The application associated with the primary operating system is executed in a user mode layer, acting as an agent of the primary operating system, and fulfilling the request by providing the secondary operating system with access to resources associated with the computing device.

### TECHNICAL FIELD

The present disclosure relates generally to computing systems, and more particularly, to providing multiple operating systems with access to hardware on a computing device.

### BACKGROUND

In today's world, having dual mobile operating systems in devices, such as laptops, has become more common as people want to have access to features of multiple operating systems. Windows has been the primary operating system for most laptops, along with Linux based operating systems. Recently, with the increase in popularity of Android in smartphones, a trend is emerging pushing Android as a secondary operating systems in notebooks and netbooks. Since Android has the advantage of a mature application market, along with developer support, there is an increasing push from the market to run Android in parallel with Windows.

While there have been attempts to run multiple operating systems on personal communication devices, such attempts are cumbersome and suffer from poor performance.

It is with respect to these and other considerations that the disclosure presented herein has been made.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the disclosure.

According to an illustrative embodiment, a method is provided for providing a secondary operating system with access to resources associated with a computing device executing a primary operating system. A request is received from a first application associated with the secondary operating system at a hardware abstraction layer associated with the secondary operating system. The secondary operating system is a virtual operating system executing as a guest of the primary operating system. The first application and the hardware abstraction layer are executed in a user mode layer associated with the secondary operating system. The request is sent from the hardware abstraction layer associated with the secondary operating system to a second application associated with the primary operating system. The second application is executed in a user mode layer associated with the primary operating system. The second application acts as an agent of the primary operating system and fulfills the request by providing the secondary operating system with access to the resources associated with the computing device.

According to another embodiment, a computing system includes a processor and a memory. The memory has stored thereon instructions which, when executed by the processor, cause the processor to perform operations. The operations comprise executing a primary operating system and executing a secondary operating system as a virtual operating system which is a guest of a primary operating system including. The operations further comprise executing a first application associated with the secondary operating system in a user mode layer associated with the secondary operating system, executing a hardware abstraction layer associated with the secondary operating system in the user mode layer associated with the secondary operating system, and executing a second application associated with the primary operating system in a user mode layer associated with the primary operating system. The second application acts as an agent of the primary operating system. A request received from the first application associated with the secondary operating system at the hardware abstraction layer is sent from the hardware abstraction layer to the second application associated with the primary operating system. The request is fulfilled by the second application acting as the agent of the primary operating system to provide the secondary operating system with access to resources associated with the computing device.

According to another embodiment, a computer readable storage device has instructions stored thereon which, when executed by a processor, cause the processor to perform operations. The operations comprise executing a primary operating system and executing a secondary operating system as a virtual operating system which is a guest of a primary operating system including. The operations further comprise executing a first application associated with the secondary operating system in a user mode layer associated with the secondary operating system, executing a hardware abstraction layer associated with the secondary operating system in the user mode layer associated with the secondary operating system, and executing a second application associated with the primary operating system in a user mode layer associated with the primary operating system. The second application acts as an agent of the primary operating system. A request received from the first application associated with the secondary operating system at the hardware abstraction layer is sent from the hardware abstraction layer to the second application associated with the primary operating system. The request is fulfilled by the second application acting as the agent of the primary operating system to provide the secondary operating system with access to resources associated with the computing device.

### BRIEF DESCRIPTION OF THE DRAWINGS

FIG. 1 is a diagram of a conventional Android architecture.

FIG. 2 is a diagram of a conventional Windows architecture.

FIG. 3 illustrates in detail how execution of an Android operating system occurs on bare metal.

FIG. 4 illustrates dual mode operating system architecture according to an illustrative embodiment.

FIGS. 5A and 5B illustrate a method for fulfilling a request of a secondary operating system for accessing hardware resources associated with a computing device executing a primary operating system.

FIG. 6 is a block diagram of a computing device with which illustrative embodiments may be implemented.

### DETAILED DESCRIPTION

Detailed illustrative embodiments are disclosed herein. It must be understood that the embodiments described and illustrated are merely examples that may be embodied in various and alternative forms, and combinations thereof. As used herein, the word “illustrative” is used expansively to refer to embodiments that serve as examples or illustrations. The figures are not necessarily to scale and some features may be exaggerated or minimized to show details of particular components. Specific structural and functional details disclosed herein are not to be interpreted as limiting.

Computer operating systems are typically built upon a layered approach. One advantage of the layered operating structure is that each layer of code is given access only to the layer below it. This structure also allows an operating system to be debugged, starting at the lowest layer and adding one layer at a time until the whole system works correctly. Layering also makes it easier to enhance the operating system, as one entire layer can be replaced without affecting other parts of the operating system.

Computer operating systems provide different levels of access to resources to different layers. A protection ring is one of two or more hierarchical levels or layers of privilege within the architecture of a computer system. This is generally hardware-enforced by CPU architectures that provide different CPU modes at the hardware or microcode level. Rings are arranged in a hierarchy from most a privileged ring (most trusted, usually numbered zero) to a least privileged ring (least trusted, usually with the highest ring number). The more privileges a ring has, the more protected it is.

In most operating systems, Ring 0 is the level with the most privileges and interacts most directly with the physical hardware, such as the CPU and memory. Ring 1 has fewer privileges. Ring 2 has even fewer privileges, and Ring 3 is the least protected. Unprivileged applications typically run in Ring 3, while privileged applications run in Ring 2.

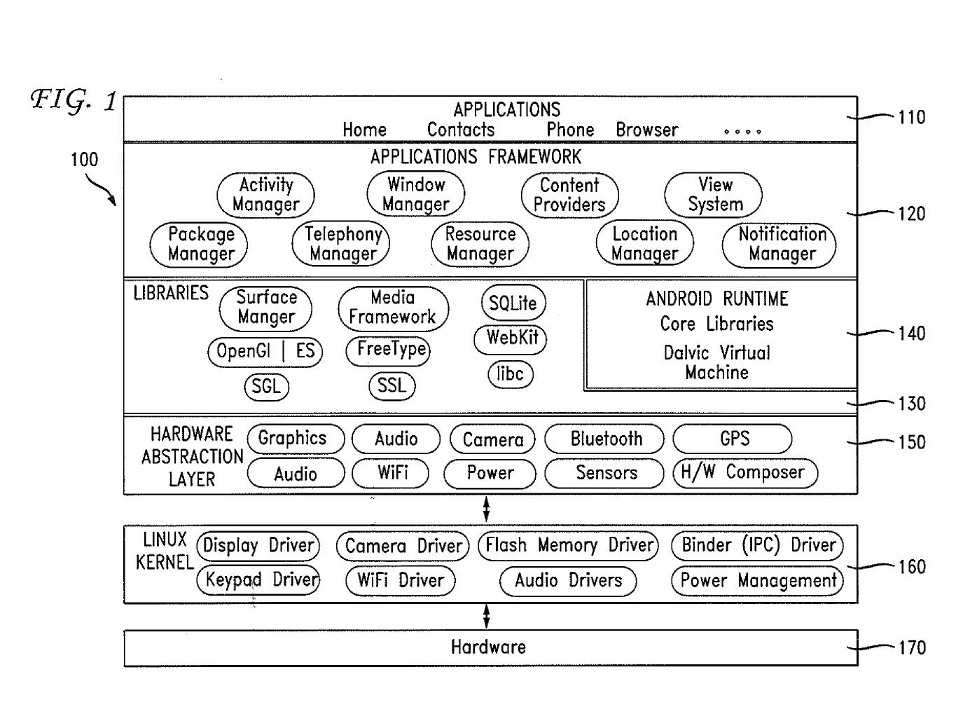

FIG. 1 is a diagram of a conventional Android architecture. The Android architecture 100 depicted in FIG. 1 includes a software stack including an applications layer 110, an application framework layer 120, a libraries layer 130, a runtime layer 140, a hardware abstraction layer 150, and a kernel layer 160. In a bare metal execution arrangement, the applications layer 110, the application framework layer 120, the libraries layer 130, the runtime layer 140, and the hardware abstraction layer 150 run in Ring 3. The kernel 160 runs in Ring 0 and has the most privileges

The applications layer 110 includes various applications, which may be written in JAVA. These applications, include, e.g., a calendar, a contacts list, an email client, SMS program maps, a phone application, a web browser application, etc.

The application framework 120 is used by developers to access framework application programming interfaces (APIs) and manage the basic functions of a mobile device, laptop, or tablet on which Android is executed, such as resource allocation, switching between processes or programs, phone applications, and keeping track of the physical location of the phone/laptop/tablet. The application framework 120 includes various managers, including an activity manager, a window manager, a content provider manager, a view system manager, a package manager, a telephony manager, a resource manager, a location manager, and a notification manager.

The library layer 130 includes libraries written, e.g., in C, C++, etc., and is used by various systems. The libraries instruct the device executing Android how to handle different kinds of data and are exposed to Android developers via the application framework 120. Libraries may include, e.g., a surface manager, a media framework library, an SQLite library, an Open GL/ES library, a Free Type library, a WebKit library, an SGL library, an SSL library, and an libc library.

The Android runtime layer 140, which includes a set of core libraries and a Dalvik Virtual Machine (DVM), is also located in the library layer 130. The runtime layer 140 includes the set of base libraries that are required for JAVA libraries. Every Android application gets its own instance of Dalvik virtual machine. Dalvik has been written so that a device can run multiple virtual machines efficiently with minimal memory.

The hardware abstraction layer 150 provides a standard way to create software hooks in between the Android platform stack and the hardware. The hardware abstraction layer 150 also acts as an abstraction layer between the hardware 170 and the rest of the software stack. The Linux kernel layer 160 includes Android memory management programs, security settings, power management software and several drivers for hardware, file system access, networking, and inter-process-communication.

The hardware layer 170 includes physical hardware including, e.g., a hard drive for storing data, a processor for executing applications, and a memory which may include an operating system winch controls scheduling of tasks and access to system resources.

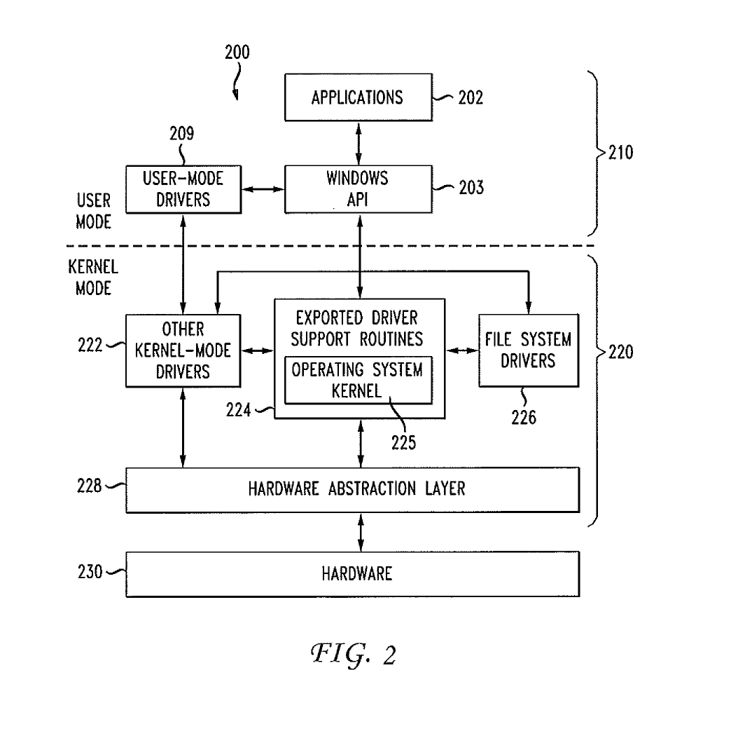

FIG. 2 illustrates a conventional Windows architecture. The Windows architecture shown in FIG. 2 represents an example of a Windows 8 operating system. However, it should be appreciated that the other versions of Windows are contemplated. The Windows architecture 200 operates in two modes. These two modes are represented in FIG. 2 as the kernel mode 220 and the user mode 210. The components in the user mode are 210 considered to reside in Ring 3, the least privileged. The components in the kernel mode 220 are run in in Ring 0, the most privileged.

The user mode 210 has four primary responsibilities: special system support processes, services that are server processes, environment subsystems, and user applications. The special support processes include, e.g., the logon process and the session manager. The services that are server processes, include, e.g., the event log and schedule services. The environment subsystems provide an operating system environment by exposing the native operating system services to user applications.

The user mode includes user applications 202, such as Win32 applications, Windows 3.1, MS-DOS, POSIX, OS/2 applications, etc. The applications 202 may also include applications similar to the applications shown in FIG. 1, e.g., various user applications, such as camera applications, a phone application, a browser application etc.

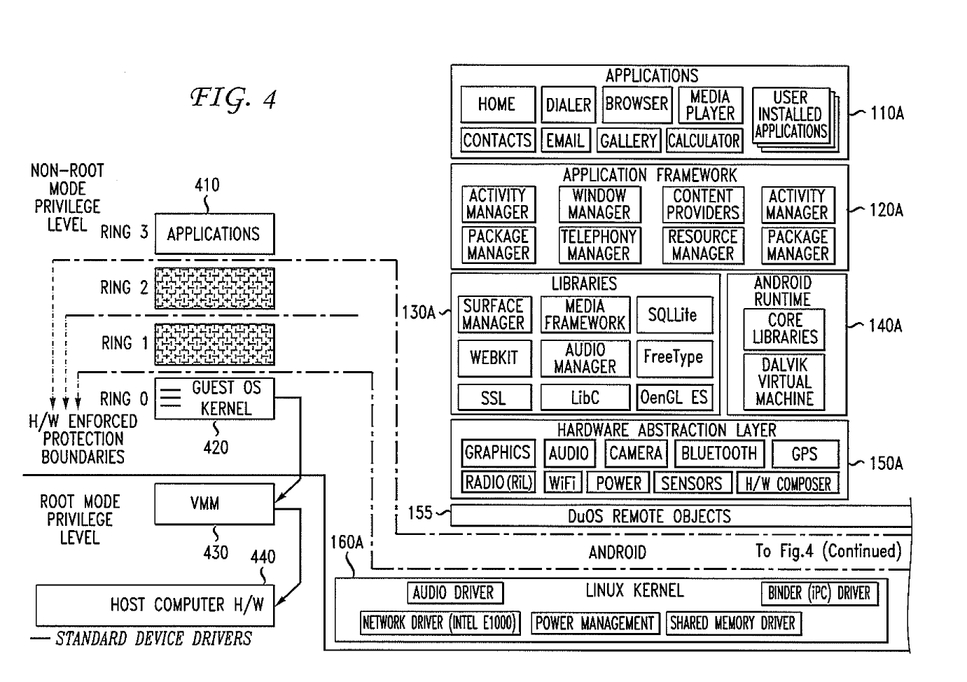

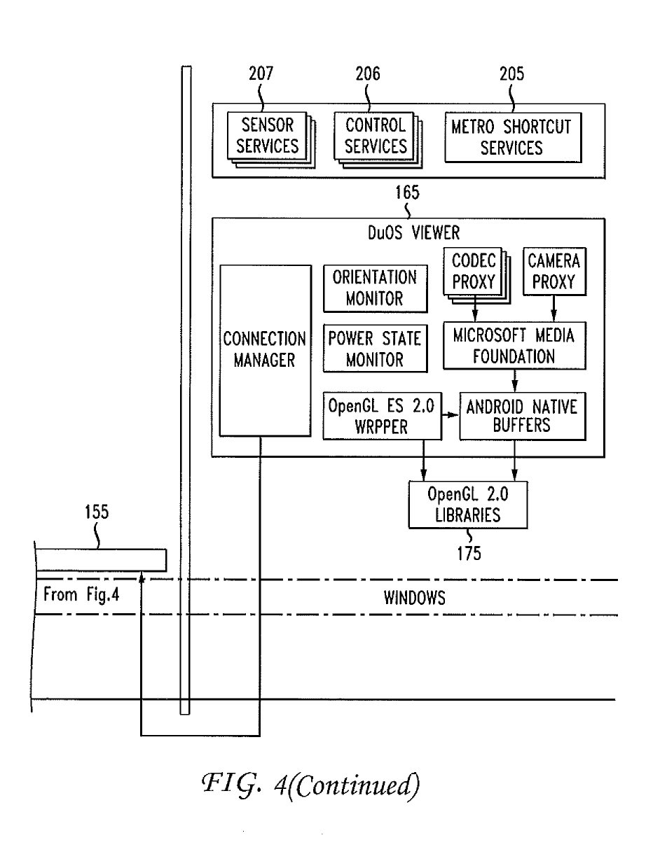

The user mode 210 also includes a Windows Application Programming Interface (API) 203. The Windows API may provide access to services, such as sensor services, control services and metro shortcut services, illustrated as services 207, 206, and 205 in FIG. 4. The services may also include other types of services, e.g., Windows 3.1, MS-DOS, POSIX, OS/2 services, etc. The services may be considered special types of applications that may be started automatically at system boot, e.g., event logging and scheduling.

In the user mode, software is not able to access hardware directly. Access to hardware is provided to the user mode 210 via the kernel mode 220. In the kernel mode 220, software is able to access the hardware and system data, as well as access all other system resources.

The kernel mode 220 has the following components: exported driver support routines 224 including the operating system kernel (also referred to as the microkernel) 225, file system drivers 226, other kernel-mode drivers 222 and the Windows hardware abstraction layer (HAL) 228.

The file system drivers 226 and the other kernel-mode drivers 222 enable the kernel layer 220 to interact with the hardware layer 230 via the hardware abstraction layer 228. Each of the drivers has well defined system routine and interval routes that it exports to the rest of the operating system. The drivers 222 and 226 send and receive load parameters and configuration data from the registry.

The microkernel 225 provides multiprocessor synchronization, thread and interrupt scheduling and dispatching, and trap handling and exception dispatching. During system startup, it extracts information from the registry, such as which device drivers to load and in what order.

Although not shown in the interest of simplifying the illustration, it should be appreciated that the kernel mode 220 may also include additional components, e.g., executive layer components. These components may include components that implement memory management, process and thread management, security, I/O, interprocess communication, and other base operating system services.

These components may also include an object manager and a Virtual Memory Manager (VMM) that manages the virtual address space of each process, shares memory between processes, and protects each process's virtual memory. All I/O devices, network ports, printers, drives, and so on are mapped to virtual files. These virtual files are referred to as file objects and are managed by the object manager just like any other object. These components may also include a process manager that sees processes as objects. Its responsibility is to create and terminate processes and threads. It also suspends and resumes the execution of threads, and stores and retrieves information about processes and threads.

The hardware abstraction layer 228 includes code associated with the Windows operating system that changes with the hardware that the operating system is being run on. Thus, it is compatible with multiple processor platforms. The hardware abstraction layer 228 manipulates the hardware 230 directly.

The hardware layer 230 includes physical hardware including, e.g., a hard drive for storing data, a processor for executing applications, and a memory which may include an operating system which controls scheduling of tasks and access to system resources.

While the Android architecture and Windows architecture described above are useful for different reasons, there has been a push to have multiple operating systems on a single computing device. Several attempts have been made to accomplish this.

Some approaches have involved running Android using full virtualization technology. Virtualization is commonly used to allow a guest operating system with access to hardware of a computing device by executing the guest operating system as an application and executing another application, e.g., a virtual machine manager (VMM) that emulates the hardware of the computing device to the guest operating system. While virtualization is a common approach, it suffers from a lack of performance, as several “calls” must be made via the VMM which, turn, accesses the host hardware. An exception is created every time an attempt is made to access the hardware, which results in penalties. Full virtualization is thus very slow.

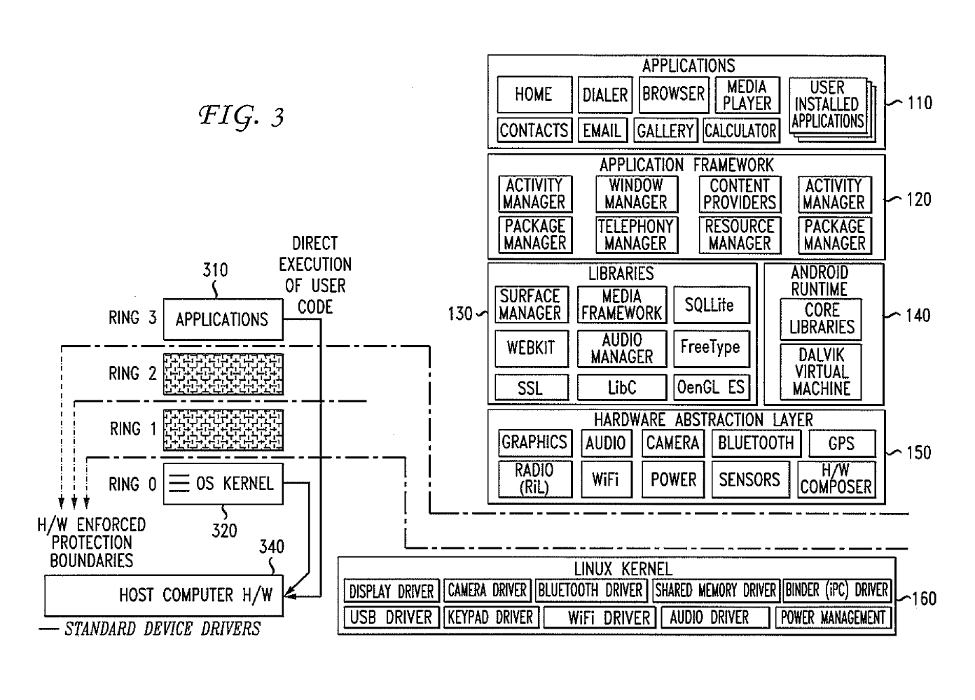

According to an illustrative embodiment, the architecture of the Android operating system is leveraged to improve performance when the Android operating system is ported to a Windows-based computing device that is executing Windows as its primary operating system. To understand this, FIG. 3 illustrates in detail how execution of an Aroid operating system occurs on bare metal.

Referring to FIG. 3, the Linux kernel runs in Ring 0, and the applications 110, the application framework 120, the libraries 130, and runtime 140, and the hardware abstraction layer run in Ring 3. Rings 1 and 2 are not used. Protection levels between applications with the OS kernel are enforced by the CPU. In this scenario, there is direction execution of user code in the applications by the host computer hardware. While this architecture provides good performance, all device drivers must be present for the operating system and must be up to date. Also, for an operating system having this architecture to be ported to different hardware, the corresponding hardware abstraction layer modules have to be ported/added.

According to an illustrative embodiment, the native architecture of the Android operating system is leveraged to enhance performance when the Android operating system is executed as a virtual operating system which is a guest of a host operating system, e.g., a Windows OS. This may be understood with reference to FIG. 4 which illustrates a dual operating system architecture according to an exemplary embodiment. This architecture is similar to a native Android operating system architecture in many ways. It uses full virtualization with hardware assists. All protection levels and Ring levels are similar to the Android native implementations. There is no change in the guest operating system. Only the modules that need to be ported to new hardware are ported. The rest of the Android code remains intact. When the dual operating system is ported to a different hardware platform, no changes are required to the guest operating system. The dual operating system architecture works with standard Windows components that are widely available.

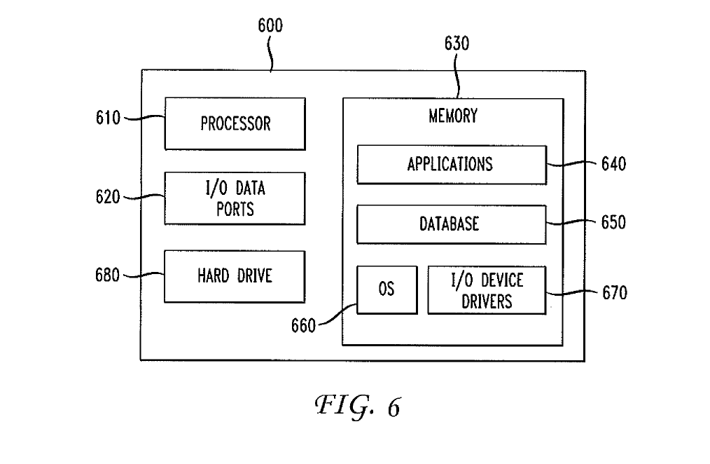

Referring to FIG. 4, the architecture 400, which may be included in a computing device such as that shown in FIG. 6, includes a Windows architecture similar to that shown in FIG. 2 with enhancements for running an Android operating system. It should be appreciated that in the diagram shown in FIG. 4, several elements of the Windows architecture have been omitted for simplicity of illustration. Although various elements of the Windows architecture are not shown, such elements are considered part of the architecture of the system shown in FIG. 4.

The architecture 400 includes software architecture having a user mode layer (indicated by the dashed line below the applications 410) and a kernel mode layer (indicated by the dashed line above the guest OS kernel 420). As illustrated in FIG. 4, the components in the user mode may be considered to reside in Ring 3, the least privileged. The components in the kernel mode may be considered to run in Ring 0, the most privileged.

In the user mode, software is not able to access hardware directly. The user mode includes Window services 205, 206, and 207 and Android applications 110A, application framework 120A, libraries 130A, runtime 140A and the Hardware Abstraction Layer 150A. The user mode also includes a DuOS remote object 155 and a DUOS viewer 165 and access to OpenGL 2.0 Libraries 175, which are explained in further detail below. The kernel mode includes the guest operating system linux kernel 160A.

The software that is part of the guest operating system (in this case the Android operating system), whether it is run in the user mode or the kernel mode, operates at the non-root model privileged level. A virtual machine manager (VMM) 430 is executed at the root mode privilege level.

The hardware layer 440 includes physical hardware including, e.g., a hard drive for storing data, a processor for executing applications, and a memory which may include code for running, e.g., the Windows operating system to control scheduling of tasks and access to system resources, along with code for executing other software represented in FIG. 4.

According to an illustrative embodiment, access to resources of the host operating system (in this case the Windows operating system) is provided to the guest operating system (in this case the Android operating system) via the DUOS remote object 155, the DUOS viewer 165, and the OpenGL 2.0 Libraries 175. The DUOS remote object 155 enables a request from an Android application to be relayed to the DUOS viewer 165. The DuOS viewer 165 is an application associated with the Windows OS, which is executed by the processor in a user mode layer associated with the host Windows OS. The DuOS viewer 165 acts as an agent of the Windows OS, supporting the graphics, keyboard, touchscreen mouse, etc.

As shown in FIG. 4, the DUOS viewer 165 includes a connection manager for handling communications to/from the DUOS remote object 155 and monitors for monitoring sensors, e.g., an orientation monitor, a power state monitor, etc. The DUOS viewer 165 further includes proxies, e.g., a codec proxy and a camera proxy, which are in communication with a Microsoft Media Foundation, an Android Native Buffer, and an OpenGL ES 2.0 Wrapper. Through the DuOS viewer 165, applications of the Android operating system are able to access the hardware and system data of the Windows OS.

The Android Native Buffer and the OpenGL ES 2.0 Wrapper of the DuOS viewer 165 are in communication with OpenGL libraries 175. The OpenGL 2.0 Libraries is a cross-language, multi-platform API for rendering 2D and 3D computer graphics. The API is used to interact with a Graphics processing unit (GPU), to achieve hardware-accelerated rendering. Together, the components of the DuOS viewer 165 and the OpenGL libraries 175, enable graphic layer emulation and rendering of graphics, e.g., pictures, captured using resource, e.g., a camera, operated by the computing device supporting the Windows OS.

Also included in the user mode 410 are services including sensor services 207, control services 206, and metro shortcut services 205. These services are executable applications that run along with the DuOS viewer 165. Although shown as distinct services, it should be appreciated that the services 207, 206, and 205 may be integrated as part of the DUOS viewer 165. The sensor services 207 act as an agent providing support for GPS, ambient light sensors, etc. The control services 206 act as an agent providing support for an accelerometer, an orientation sensor etc. The metro shortcut services 205 act as an agent, providing support for Windows shortcuts. A request from a Windows application is forwarded by an appropriate one of the services 207, 206, or 205 to a driver which, in turn access the hardware via the hardware abstraction layer of the Windows OS.

As an example of how the architecture shown in FIG. 4 may work, consider a camera application. If the camera application is accessed via Windows, the Windows camera application requests the camera driver included in the Windows driver (e.g., the drivers 222 shown in FIG. 2) for a picture. The camera driver accesses the actual camera in the hardware layer (shown as 230 in FIG. 2) via a request sent via the hardware abstraction layer (shown in FIG. 2 as 228) and provides the picture to the requesting application.

If the camera application is accessed via Android, the Android camera application requests the camera hardware layer for a picture, and the request is routed to DUOS viewer application 165 via the hardware abstraction layer 150A and the DUOS remote object 155. The DUOS viewer application 165 requests the Windows camera driver for a picture. The camera driver accesses the actual camera and provides the captured frames to the DuOS viewer application 165. Only the data portion of the captured frames is sent to the Android operating system via the DUOS remote object 155. Encoding and other processing of the captured frames occurs on the Windows operating system.

As another example, consider a GPS application. The Android GPS application requests the GPS hardware layer for location information by sending a request via the DuOS remote object 155 to the sensor services 207. This request is fulfilled by accessing the actual hardware of the computing devices executing the Windows OS.

According to an exemplary embodiment, the architecture 400 may be included in a device, such as a tablet. However, the architecture may also be included in other devices, e.g., a workstation, a telephone, a desktop computer, a laptop, a notebook computer, a server, a handheld computer, a media playing device, a gaming system, a mobile computing device, or any other type and/or form of computing, telecommunications, or media device that is capable of communication.

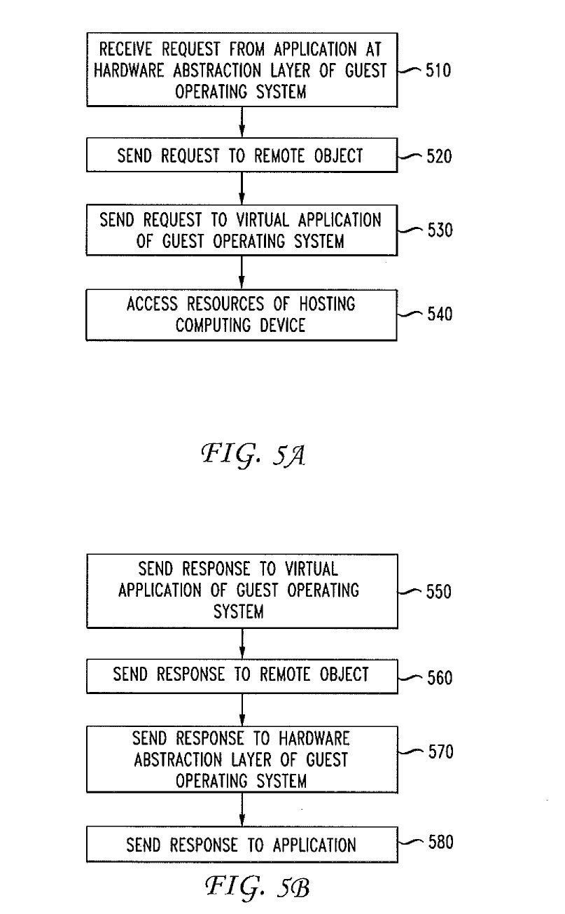

FIGS. 5A and 5B illustrate a method for fulfilling a request of a secondary operating systems for accessing hardware resources associated with a computing device executing a primary operating system according to an illustrative embodiment. It should be understood that the steps or other interactions of the illustrated method are not necessarily presented in any particular order and that performance of some or all the steps in an alternative order is possible and is contemplated. The steps have been presented in the demonstrated order for ease of description and illustration. Steps can be added, omitted and/or performed simultaneously without departing from the scope of the appended claims. It should also be understood that the method can be ended at any time. In certain embodiments, some or all steps of the method, and/or substantially equivalent steps can be performed by execution of computer-executable instructions stored or included on computer-readable storage device, excluding a propagating signal.

Referring to FIG. 5A, a request is received at step 510 from an application associated with the guest operating system, the applications 110A of the the Android operating system, at a hardware abstraction layer associated with the guest operating system, e.g., the hardware abstraction layer 150A. The guest operating system is a virtual operating system executing as a guest of the primary operating system.

At step 520, the request is sent to a remote object associated with the secondary operating system, e.g., the DUOS remote object 155. At step 530, the request is sent from the remote object associated with the guest operating system to an application associated with the primary operating system, e.g., the DUOS viewer 165. The application associated with the primary operating system acts as an agent of the primary operating system. At step 540, resources of the host computing device are accessed via that agent.

At step 550, a response fulfilling the request is sent from the agent, e.g., the DUOS viewer 165, to the remote object, e.g., the DUOS object 155, associated with the guest operating system. At step 570, the response is sent to the hardware abstraction layer of the guest operating system, e.g., the hardware abstraction layer 150A. At step 580, a response is sent to the application of the guest operating system that sent the request, e.g., the applications 110.

Although not shown, it should be appreciated that a request from an application associated with the host operating system, e.g., the Windows OS, for accessing resources associated with the host operating system may be fulfilled in a conventional way, e.g., by routing the request from a driver to the hardware via the hardware abstraction layer and fulfilling the request via the hardware abstraction layer and the driver.

FIG. 6 is a block diagram of a computing device 600 with which the software architecture of FIG. 4 may be implemented. The computing device 600 may be included within a device, such as a notebook or tablet. Referring to FIG. 6, the computing device 600 includes a processor 610 that receives inputs, e.g., user requests, and transmits outputs, e.g., responses to user requests via I/O Data Ports 620. The I/O Data Ports 620 can be implemented with, e.g., an interface including an antenna or other suitable type of transceiver through which data and signals may be transmitted and received wired and/or wirelessly.

The computing device 600 also includes a physical hard drive 680. The processor 610 communicates with the memory 630 and the hard drive 680 via, e.g., an address/data bus (not shown). The processor 610 can be any commercially available or custom microprocessor. The memory is 630 is representative of the overall hierarchy of memory devices containing the software and data used to implement the functionality of the device 600. The memory 630 can include, but is not limited to, the following types of devices: processor registers, processor cache, RAM, ROM, PROM, EPROM, EEPROM, flash memory, SRAMD, DRAM other volatile memory forms, and non-volatile, semi-permanent or permanent memory types, excluding propagating signals. For example, the memory may include tape-based media, optical media, solid state media, hard disks, combinations thereof, and the like.

As shown in FIG. 6, the memory 630 may include several categories of software and data used in the device 600, including applications 640, a database 650, an operating system (OS) 660, and input/output (110) device drivers 670. The applications 640 include various programs that implement the various features of the device 600, including, e.g. a virtual machine manager (VMM) application for emulating physical hardware to a virtual operating system acting a guest operating system, e.g., the Android OS. The memory 630 may also include services, which may be considered a special category of applications 640. As will be appreciated by those skilled in the art, the OS 660 may include code for any operating system for use with a data processing system, e.g., a Windows OS. According to an illustrative embodiment, the Windows OS is the run as the primary operating system, while an Android OS is run as a guest operating system in a user mode layer associated with the primary operating system. The Android OS may be stored as a file within the memory 630. The Android OS file is emulated as a hard disk for the guest operating system.

The I/O device drivers 670 may include various routines accessed through the OS 660 by the applications to communicate with devices and certain memory components.

The applications 640 can be stored in the memory 630 and/or in a firmware (not shown) as executable instructions, and can be executed by the processor 610. The database 650 represents the static and dynamic data used by the applications 640, the OS 660, the I/O device drivers 670 and other software programs that may reside in the memory.

While the memory 630 is illustrated as residing proximate the processor 610, it should be understood that at least a portion of the memory 630 can be a remotely accessed storage system, for example, a server on a communication network, a remote hard disk drive, a removable storage medium, combinations thereof, and the like. Thus, any of the data, applications, and/or software described above can be stored within the memory 630 and/or accessed via network connections to other data processing systems (not shown) that may include a local area network (LAN), a metropolitan area network (MAN), or a wide area network (WAN), for example.

It should be understood that FIG. 6 and the description above are intended to provide a brief, general description of a suitable environment in which the various aspects of some embodiments of the present disclosure can be implemented. While the description refers to computer-readable instructions, the present disclosure also can be implemented in combination with other program modules and/or as a combination of hardware and software in addition to, or instead of, computer readable instructions. The term “application,” or variants thereof, is used expansively herein to include routines, program modules, programs, components, data structures, algorithms, and the like. Applications can be implemented on various system configurations, including single-processor or multiprocessor systems, minicomputers, mainframe computers, personal computers, hand-held computing devices, microprocessor-based, programmable consumer electronics, combinations thereof, and the like. The terminology “computer-readable media”, “computer-readable storage device” and variants thereof, as used in the specification and claims, can include storage media. Storage media can include volatile and/or non-volatile, removable and/or non-removable media, such as, for example, RAM, ROM, EEPROM, flash memory or other memory technology, CDROM, DVD, or other optical disk storage, magnetic tape, magnetic disk storage, or other magnetic storage devices or any other medium that can be used to store information, excluding propagating signals.

The law does not require and it is economically prohibitive to illustrate and teach every possible embodiment of the present claims. Hence, the above-described embodiments are merely exemplary illustrations of implementations set forth for a clear understanding of the principles of the invention. Variations, modifications, and combinations may be made to the above-described embodiments without departing from the scope of the claims. All such variations, modifications, and combinations are included herein by the scope of this disclosure and the following claims.

What is claimed is:

1. A method for providing a secondary operating system with access to resources associated with a computing device including a processor executing a primary operating system, comprising:
receiving a request from a first application associated with the secondary operating system at a hardware abstraction layer associated with the secondary operating system, wherein the secondary operating system is a virtual operating system executing as a guest of the primary operating system, and wherein the first application and the hardware abstraction layer are executed by the processor in a user mode layer associated with the secondary operating system;
sending the request from the hardware abstraction layer associated with the secondary operating system to a second application executed by the processor in a user mode layer associated with the primary operating system, wherein the second application acts as an agent of the primary operating system and fulfills the request by providing the secondary operating system with access to resources associated with the computing device.

2. The method of claim 1, wherein the request is sent from the hardware abstraction layer to the second application via an object associated with the secondary operating system.

3. The method of claim 1, wherein the first application and the hardware application layer associated with the second operating system are executed in Ring 3 of the user mode layer associated with the second operating system, and the second application is executed in Ring 3 of the user mode layer associated with the primary operating system.

4. The method of claim 1, wherein the secondary operating system is an Android operating system.

5. The method of claim 1, wherein the primary operating system is a Windows operating system.

6. The method of claim 1, wherein the second application provides access to peripherals associated with the computing device.

7. The method of claim 6, wherein the peripherals comprises sensors.

8. A computing device, comprising:
a processor; and
a memory having stored thereon instructions which, when executed by the processor, cause the processor to perform operations comprising:
executing a primary operating system;
executing a secondary operating system as a virtual operating system which is a guest of a primary operating system including;
executing a first application associated with the secondary operating system in a user mode layer associated with the secondary operating system;
executing a hardware abstraction layer associated with the secondary operating system in the user mode layer associated with the secondary operating system;
executing a second application in a user mode layer associated with the primary operating system, wherein the second application acts as an agent of the primary operating system, and wherein a request is received from first application associated with the secondary operating system at the hardware abstraction layer, the request is sent from the hardware abstraction layer to the second application, and the request is fulfilled by the second application acting as the agent of the primary operating system to provide the secondary operating system with access to resources associated with the computing device.

9. The computing device of claim 8, wherein the operations performed by processor further comprises executing an object associated with the secondary operating system, wherein the request is sent from the hardware abstraction layer to the second application via the object.

10. The computing device of claim 8, wherein the processor executes the first application and the hardware application layer associated with the second operating system in Ring 3 of the user mode layer associated with the second operating system, and the processor executes the second application in Ring 3 of the user mode layer associated with the primary operating system.

11. The computing device of claim 8, wherein the secondary operating system is an Android operating system.

12. The computing device of claim 8, wherein the primary operating system is a Windows operating system.

13. The computing device of claim 8, wherein the second application provides access to peripherals associated with the computing device.

14. The computing device of claim 13, wherein the peripherals comprise sensors.

15. A computer readable storage device having instructions encoded thereon which, when executed by a processor, cause the processor to perform operations comprising:
receiving a request from a first application associated with the secondary operating system at a hardware abstraction layer associated with the secondary operating system, wherein the secondary operating system is a virtual operating system executing as a guest of the primary operating system, and wherein the first application and the hardware abstraction layer are executed by the processor in a user mode layer associated with the secondary operating system;
sending the request from the hardware abstraction layer associated with the secondary operating system to a second application, wherein the second application is executed by the processor in a user mode layer associated with the primary operating system, and wherein the second application acts as an agent of the primary operating system and fulfills the request by providing the secondary operating system with access to resources associated with the computing device.

16. The computer readable storage device of claim 15, wherein the request is sent from the hardware abstraction layer to the second application via an object associated with the secondary operating system.

17. The computer readable storage device of claim 15, wherein the first application and the hardware application layer associated with the second operating system are executed in Ring 3 of the user mode layer associated with the second operating system, and the second application is executed in Ring 3 of the user mode layer associated with the primary operating system.

18. The computer readable storage device of claim 15, wherein the secondary operating system is an Android operating system.

19. The computer readable storage device of claim 15, wherein the primary operating system is a Windows operating system.

20. The computer readable storage device of claim 15, wherein the virtual application provides access to peripherals associated with the computing device.
